(19) United States
(12) Patent Application Publication
(10) Pub. No.: US 2025/0358513 A1
(43) Pub. Date: Nov. 20, 2025

(54) FOCUS CONTROL APPARATUS, IMAGING APPARATUS, AND FOCUS CONTROL METHOD

(71) Applicant: CANON KABUSHIKI KAISHA, Tokyo (JP)

(72) Inventors: HIROKAZU ISHII, Tokyo (JP); YU INAGAKI, Tokyo (JP)

(21) Appl. No.: 19/193,673

(22) Filed: Apr. 29, 2025

(30) Foreign Application Priority Data
May 15, 2024 (JP) 2024-079798

(51) Int. Cl. H04N 23/67; H04N 23/55; H04N 23/63

(52) U.S. Cl. CPC H04N 23/675; H04N 23/55; H04N 23/633

(57) ABSTRACT

Focus control apparatuses, imaging apparatuses, methods, and storage mediums are provided herein. At least one focus control apparatus includes one or more processors that execute a program stored in a memory and function as a focus detection unit operating to perform focus detection, and a control unit operating to control driving of a focus lens included in an optical system based on a focus detection result obtained by the focus detection, wherein the control unit performs control to cause a relationship between a rotation direction of a ring member rotationally operable by a user and a driving direction of the focus lens to correspond to a relationship between the rotation direction of the ring member and a search direction, and starts a search operation in which the focus detection is performed at predetermined intervals while the focus lens is moved based on a rotation amount of the ring member.

### BACKGROUND

### Field of the Disclosure

One or more features of the present disclosure relate to one or more embodiments using focus adjustment (focus) control.

### Description of the Related Art

Some imaging apparatuses perform a search operation in which a focus lens is moved to search for an in-focus position. Japanese Patent Application Laid-Open No. 2007-164051 discusses a technique in which a user specifies either a distant view or a close view, and a search process is limited to the distant view area or the close view area by setting a search start position as an end point, allowing rapid focusing on an object desired by the user. In the technique, a first switch and a second switch are provided. With the first switch turned on, the search process is performed on the distant view area with a current lens position as the end point of the close view area. With the second switch turned on, the search process is performed on the close view area with the current lens position as the end point of the distant view area.

However, the method discussed in Japanese Patent Application Laid-Open No. 2007-164051 involves switching of the plurality of switches to perform the search process, which makes the operation complicated and less intuitive for the user.

### SUMMARY

One or more aspects of embodiments of the present disclosure have been made in consideration of the above situation, and are directed to providing one or more embodiments of a focus control apparatus and/or of a focus control method in which search processing may be performed with more intuitive operation.

According to one or more aspects of the present disclosure, at least one embodiment of a focus control apparatus may include one or more processors that execute a program stored in a memory, and the one or more processors operating to function as a focus detection unit that operates to perform a focus detection, and as a control unit that operates to control a driving of a focus lens included in an optical system based on a focus detection result obtained by the focus detection, wherein the control unit: (i) performs control to cause a relationship between a rotation direction of a ring member that operates to be rotated and a driving direction of the focus lens to correspond to a relationship between the rotation direction of the ring member and a search direction, and (ii) starts a search operation in which the focus detection is performed at predetermined intervals while the focus lens is moved based on a rotation amount of the ring member. In one or more embodiments, the ring member operates to be rotated by a user.

According to other aspects of the present disclosure, one or more additional focus control apparatuses, one or more imaging apparatuses, one or more focus control methods, one or more imaging methods, one or more calculation or other methods, and one or more storage mediums are discussed herein. Further features of the present disclosure will become apparent from the following description of exemplary embodiments with reference to the attached drawings.

### BRIEF DESCRIPTION OF THE DRAWINGS

FIG. 1 is a block diagram illustrating a configuration of an imaging apparatus according to one or more embodiments of the present disclosure.

FIG. 2 is a diagram illustrating a pixel arrangement of an imaging element according to one or more embodiments of the present disclosure.

FIG. 3A is a plan view of a pixel according to one or more embodiments of the present disclosure.

FIG. 3B is a cross-sectional view of the pixel shown in FIG. 3A according to one or more embodiments of the present disclosure.

FIG. 4 is a diagram illustrating a relationship between a pixel and a pupil division according to one or more embodiments of the present disclosure.

FIG. 5 is a diagram illustrating a relationship between an imaging element and a pupil division according to one or more embodiments of the present disclosure.

FIG. 6 is a diagram illustrating a relationship between a defocus amount and an image shift amount according to one or more embodiments of the present disclosure.

FIG. 7 is a flowchart illustrating imaging processing according to one or more embodiments of the present disclosure.

FIG. 8 is a flowchart illustrating search autofocus (AF) processing according to one or more embodiments of the present disclosure.

FIG. 9 is a flowchart illustrating calculation processing of a focus driving range according to one or more embodiments of the present disclosure.

FIG. 10 is a diagram illustrating a positional relationship between an object and a background according to one or more embodiments of the present disclosure.

FIG. 11A is a diagram illustrating an object signal and a background signal while an imaging optical system focuses on the background according to one or more embodiments of the present disclosure.

FIG. 11B is a diagram illustrating an object signal and a background signal while the imaging optical system focuses on the object according to one or more embodiments of the present disclosure.

FIG. 12 is a diagram illustrating a relationship between focus lens positions and focus detection results according to one or more embodiments of the present disclosure.

FIGS. 13A to 13D are diagrams each illustrating a relationship between a search direction, a search start position, focus lens positions, a focus driving range, a focus detection result, and a driving amount according to one or more embodiments of the present disclosure.

FIG. 14 is a flowchart illustrating search AF execution determination processing according to one or more embodiments of the present disclosure.

FIG. 15 is a diagram illustrating an example of a setting screen for assigning a function to a rotational operation unit according to one or more embodiments of the present disclosure.

FIG. 16 is a diagram illustrating an example of a display screen during an execution of search AF according to one or more embodiments of the present disclosure.

### DESCRIPTION OF THE EMBODIMENTS

One or more embodiments and/or features of the present disclosure will now be described with reference to the drawings.

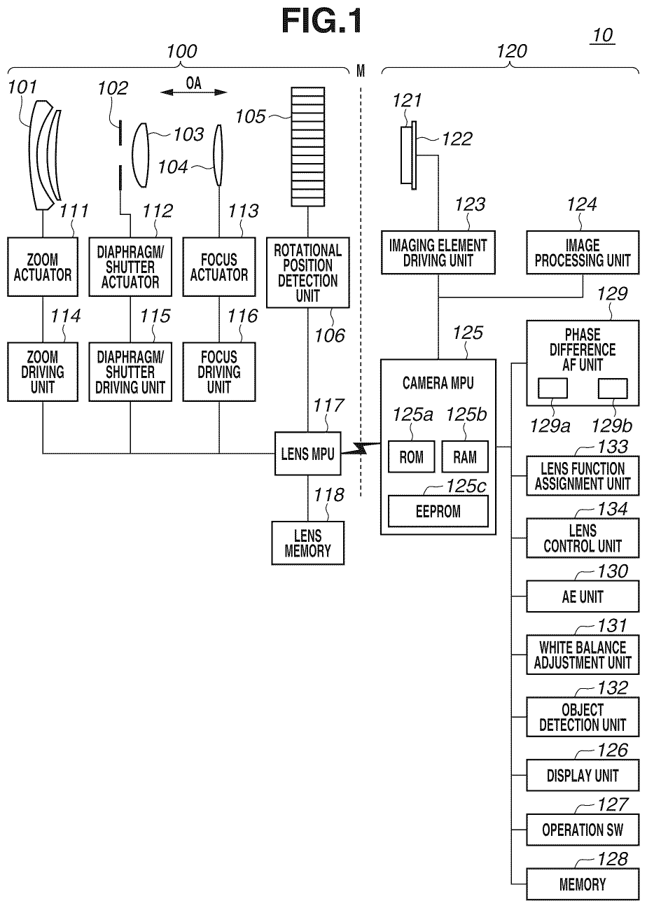

At least one present exemplary embodiment will be described. An imaging system 10 according to at least the embodiment illustrated in FIG. 1 may be an interchangeable lens digital camera system that operates to perform autofocus (AF) using an imaging plane phase difference detection system (hereinafter, referred to as an imaging plane phase difference AF). One or more features of the embodiments discussed herein may be applicable to a lens-integrated digital camera and a digital video camera. One or more features of the embodiment also may be applicable to a terminal device, such as a tablet or a smartphone, and various kinds of apparatuses, such as a monitoring camera, an on-vehicle camera, and a medical camera, all of which are capable of instruction of focus control with a ring member or remote operation of the focus control by the ring member. Further, a focus detection system is not limited to the imaging plane phase difference AF, and other focus detection systems may be used as long as information about an object distance may be obtained. For example, a time of flight (ToF) method may be employed, in which light (infrared light or laser) is emitted and the time taken for the light to hit the object and reflect back is measured to calculate the distance. In addition, a method may be employed in which a radio frequency identification (RFID) tag or an ultra-wideband (UWB) tag is attached to an object, where an antenna operates to receive signals from the tag to determine the positions.

### <Apparatus Configuration for One or More Embodiments of the Present Disclosure>

The imaging system 10 includes a lens unit 100 and a camera main body 120 as an imaging apparatus according to one or more embodiments of the present disclosure. The lens unit 100 is detachably connected to the camera main body 120 via a mount M illustrated by a dotted line at the center part in the drawing.

The lens unit 100 that forms an object image includes a first lens group 101, a diaphragm 102, a second lens group 103, a focus lens group (hereinafter, focus lens) 104, and a driving and control system described below. The lens unit 100 configures an imaging optical system that includes the focus lens 104 and forms an image of an object. The lens unit 100 may further include a lens barrel that accommodates the above-described first lens group 101 to the fourth lens group 104. A rotational operation unit 105 as a ring member rotationally operable by a user may be attached to the outer periphery of the lens barrel.

The first lens group 101 is disposed at the front end of the lens unit 100, and is held movable in optical axis directions OA. In the following, the optical axis directions OA are defined as Z directions, and a direction from a camera toward the object as a positive direction. Further, in one or more embodiments, an origin O of an axis in the Z directions corresponds to a position of an imaging element 122 of the camera main body 120 described below.

The diaphragm 102 adjusts the light quantity in imaging by adjusting its aperture diameter. The diaphragm 102 also functions as a mechanical shutter that controls the exposure time in still image capturing. The diaphragm 102 and the second lens group 103 may be integrally movable in the optical axis directions OA, and may be moved in conjunction with the first lens group 101 to perform a zoom function.

The focus lens 104 is movable in the optical axis directions OA, and an object distance (a focal distance) on which the lens unit 100 focuses varies based on the position of the focus lens 104. In one or more embodiments, the position of the focus lens 104 in the optical axis directions OA may be controlled to perform an autofocus function of detecting information about the object distance (a focus detection) and adjusting the focal distance.

The lens unit 100 includes the driving and control system (including devices, circuits, program codes, and others). The driving system of the driving and control system includes a zoom actuator 111, a diaphragm and shutter actuator 112, a focus actuator 113, a zoom driving unit 114, a diaphragm and shutter driving unit 115, and a focus driving unit 116. The control system that controls the driving system includes a lens micro-processing unit (MPU) 117 and a lens memory 118.

The zoom actuator 111 drives the first lens group 101 and the second lens group 103 forward and backward in the optical axis directions OA to perform zoom control for changing an angle of view of the imaging optical system. The diaphragm and shutter actuator 112 controls the aperture diameter of the diaphragm 102 to adjust the imaging light quantity, and controls the opening and closing operation of the diaphragm 102 to control the exposure time in imaging. The focus actuator 113 drives the focus lens 104 forward and backward in the optical axis directions OA to perform autofocus operation, and has a function of detecting a current position of the focus lens 104.

The zoom driving unit 114 drives the zoom actuator 111 based on a zoom operation by the user or a control value of the lens MPU 117. The diaphragm and shutter driving unit 115 drives the diaphragm and shutter actuator 112 to control the aperture diameter or the opening and closing operation of the diaphragm 102. The focus driving unit 116 drives the focus actuator 113, moving the focus lens 104 forward and backward in the optical axis directions OA to perform the autofocus operation (a focus adjustment operation). A rotational position detection unit 106 detects a rotational position of the rotational operation unit 105, and transmits information about the rotational position to the lens MPU 117. The lens MPU 117 can acquire an operation amount (a rotation direction and a rotation amount) of the rotational operation unit 105 from a change amount in the rotational position, and can calculate the rotation speed.

The lens MPU 117 performs all the calculations and the controls related to the imaging optical system, and controls the zoom driving unit 114, the diaphragm and shutter driving unit 115, the focus driving unit 116, the rotational position detection unit 106, and the lens memory 118. The lens MPU 117 is connected to a camera MPU 125 via the mount M so as to exchange commands and data with the camera MPU 125. For example, the lens MPU 117 detects a current position of the focus lens 104, and notifies the lens positional information in response to a request from the camera MPU 125. The lens positional information includes information about the position of the focus lens 104 in the optical axis directions OA, information about the position and the diameter of an exit pupil in the optical axis directions OA in a state where the optical system is not moved, and information about the position and the diameter of a lens frame that limits the light flux of the exit pupil in the optical axis directions OA. Further, the lens MPU 117 controls the zoom driving unit 114, the diaphragm and shutter driving unit 115, and the focus driving unit 116 in response to a request from the camera MPU 125. In one or more embodiments, the lens MPU 117 may assign a function to the rotational operation unit 105 according to a request from the camera MPU 125. Further, the lens MPU 117 can notify information about the operation amount (the rotation direction and the rotation amount) of the rotational operation unit 105 detected by the rotational position detection unit 106, and information about the rotation speed calculated by the lens MPU 117. For example, when a manual focus (MF) function is assigned to the rotational operation unit 105, the lens MPU 117 receives an operation of the rotational operation unit 105, and controls the focus driving unit 116 in response to the reception. As a result, the focus lens 104 is moved based on the operation of the rotational operation unit 105.

Optical information necessary for the imaging plane phase difference AF is previously stored in the lens memory 118.

The lens memory 118 also stores, for example, a defocus map indicating a correspondence relationship between positions and moving amounts of the focus lens 104, and defocus amounts. The defocus map is generated by calculating image shift amounts at individual pixel positions of a first focus detection signal and a second focus detection signal through correlation calculation, and then converting the image shift amounts into defocus amounts in a manner described below.

Upon receiving a request for changing the defocus amount by a predetermined amount alone from the camera MPU 125, the lens MPU 117 refers to the defocus map stored in the lens memory 118. The lens MPU 117 then controls the focus actuator 113 so as to move the focus lens 104 by a distance corresponding to the predetermined amount.

The camera MPU 125 runs programs stored in, for example, a read-only memory (ROM) 125a and the lens memory 118 to control the operation of the lens unit 100. The lens memory 118 also stores optical information about the imaging optical system according to one or more embodiments of the present disclosure.

The camera main body 120 includes an optical lowpass filter 121, the imaging element 122, and a driving and control system described below. The optical lowpass filter 121 reduces false colors and moire of captured images.

The imaging element 122 includes a complementary metal-oxide semiconductor (CMOS) image sensor and peripheral circuits thereof.

The CMOS image sensor includes a photoelectric conversion element in each pixel that receives light, and a pixel group (an imaging plane) where a plurality of unit pixels is arranged in a two-dimensional manner with each pixel as a unit pixel.

The imaging element 122 includes a plurality of focus detection pixels that receive light fluxes passing through different pupil areas of the imaging optical system, and can perform independent signal output for each pixel. Thus, the defocus amount that is a focus detection result can be calculated by using the imaging plane phase difference AF. Further, the imaging element 122 includes a plurality of imaging pixels that each receive a light flux passing through the entire area of the exit pupil of the imaging optical system that forms images of the object to generate image signals of the object.

The driving and control system of the camera main body 120 includes an imaging element driving unit 123, an image processing unit 124, the camera MPU 125 that generally controls the camera main body 120, a display unit 126, an operation switch 127, a memory 128, and a phase difference AF unit 129. The imaging element driving unit 123 controls the charge accumulation operation of the imaging element 122, converts the image signals read from the imaging element 122 into digital signals, and transmits the digital signals to the camera MPU 125. The image processing unit 124 performs various kinds of image processing, such as gamma conversion, color interpolation, and Joint Photographic Experts Group (JPEG) compression on the image signals read from the imaging element 122. Further, the image processing unit 124 generates signals for focus detection by imaging plane phase difference system described below, for exposure adjustment, for white balance adjustment, and for object detection. In one or more embodiments, the image processing unit 124 generates signals for focus detection (for phase difference AF), for exposure adjustment, for white balance adjustment, and for object detection. However, the image processing unit 124 can generate, for example, signals for exposure adjustment, for white balance adjustment, and for object detection as a common signal. A combination of the signals to be generated as the common signal is not limited thereto.

The camera MPU 125 includes a microprocessor, and performs all the calculations and the controls related to the camera main body 120. Accordingly, the camera MPU 125 controls the imaging element driving unit 123, the image processing unit 124, the display unit 126, the operation switch 127, the memory 128, the phase difference AF unit 129, an automatic exposure (AE) unit 130, a white balance adjustment unit 131, an object detection unit 132, a lens function assignment unit 133, and a lens control unit 134. The camera MPU 125 is connected to the lens MPU 117 via a signal line disposed in the mount M. Thus, the camera MPU 125 issues to the lens MPU 117 requests for acquiring a lens position, for zoom driving, diaphragm driving, and lens driving by predetermined driving amounts, and for acquiring optical information inherent to the lens unit 100.

The camera MPU 125 includes a ROM 125a that stores programs for controlling the operation of the camera, a random-access memory (RAM) 125b that stores variables, and an electrically erasable programmable read-only memory (EEPROM) 125c that stores various kinds of parameters. The camera MPU 125 reads the programs stored in the ROM 125a, loads the programs to the RAM 125b, and runs the programs to perform focus detection processing, object detection processing, exposure adjustment processing, and white balance adjustment processing described below.

The display unit 126 includes a display device, e.g., a liquid crystal display (LCD) panel or an organic electroluminescence (EL) panel, and displays various kinds of information about operation modes of the camera. Examples of the operation modes of the camera include an imaging mode for capturing still images and moving images, and a reproduction mode for reproducing captured images stored in the memory 128. In a case of the imaging mode, the display unit 126 displays information about the imaging mode of the camera, a preview image before an imaging, a confirmation image after the imaging, and an in-focus state image when focus is detected. Further, the display unit 126 continuously displays a moving image being captured.

The operation switch 127 includes a shutter switch, a power switch, a zoom switch, and a mode selection switch. The memory 128 is a flash memory detachable from the camera and records captured images.

The phase difference AF unit 129 performs focus detection processing using the phase difference detection system based on a pair of image signals with different parallax for focus detection (signals for phase difference AF) obtained from the imaging element 122 and the image processing unit 124. The image processing unit 124 generates a pair of pieces of image data with different parallax formed by light fluxes passing through a pair of pupil areas of the imaging optical system, and the phase difference AF unit 129 calculates a focus shift amount (a defocus amount) based on a shift amount of the pair of pieces of image data. In this manner, the phase difference AF unit 129 performs the phase difference AF (the imaging plane phase difference AF) by using the output signals of the imaging element 122 without a dedicated AF sensor.

The phase difference AF unit 129 includes an acquisition block 129a and a calculation block 129b.

Operation of the acquisition block 129a and the calculation block 129b will be described below. At least a part of the phase difference AF unit 129 (a part of acquisition unit 129a or calculation block 129b) can be provided in the camera MPU 125. Focus adjustment operation performed by the phase difference AF unit 129 will be described below. The phase difference AF unit 129 has an autofocus adjustment (AF) function of controlling the position of the focus lens 104 by using the focus detection result.

The object detection unit 132 performs object detection processing for detecting a type, a part, and a state (a detection type) of the object, as well as a position and a size (a detection area) of the object based on signals for object detection generated by the image processing unit 124.

The lens function assignment unit 133 selects a function to be assigned to the rotational operation unit 105. One of a plurality of functions can be selectively assigned to the rotational operation unit 105. In addition to the above-described manual focus (MF) function, a function of controlling search AF (described below) specific to one or more embodiments of the present disclosure may be assigned to the rotational operation unit 105. In addition, a diaphragm operation function of adjusting the aperture diameter of the diaphragm 102, an International Organization for Standardization (ISO) sensitivity operation function of changing ISO sensitivity of the imaging element 122, and the other functions can be included. In one or more embodiments, the function of controlling the search AF described below may be assigned to the rotational operation unit 105. A method of setting a function to be assigned to the rotational operation unit 105 will be described below.

The AE unit 130 performs photometry based on signals for exposure adjustment (for AE) obtained from the imaging element 122 and the image processing unit 124 to control the imaging condition appropriately.

The AE unit 130 performs photometry based on the signals for exposure adjustment obtained from the imaging element 122 and the image processing unit 124 to control the exposure condition. Specifically, the AE unit 130 calculates an exposure amount by using an aperture value, a shutter speed, an ISO sensitivity, all of which are currently set. Based on the difference between the calculated exposure amount and the predetermined appropriate exposure amount, an appropriate aperture value, an appropriate shutter speed, and an appropriate ISO sensitivity for an imaging are computed to be set as an exposure condition. This makes it possible to perform automatic exposure adjustment (AE).

The white balance adjustment unit 131 performs white balance adjustment processing based on signals for white balance adjustment obtained from the imaging element 122 and the image processing unit 124. The white balance adjustment unit 131 has an automatic white balance adjustment (AWB) function of adjusting color weighting based on the difference between the white balance parameters acquired from the signals for white balance adjustment and the predetermined appropriate white balance parameters.

The camera main body 120 according to the one or more embodiments may perform AF, AE, and AWB in combination with object detection, and can select positions for AF, AE, and AWB within an imaging range based on an object detection result.

### <Configuration of an Imaging Element for One or More Embodiments>

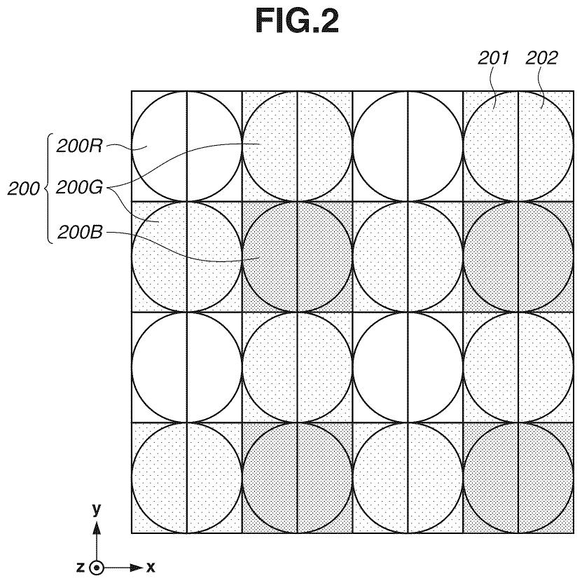

FIG. 2 illustrates an arrangement of imaging pixels in the imaging element 122 as a two-dimensional CMOS sensor in the range of four columns by four rows, and illustrates an arrangement of focus detection pixels in the range of eight columns by four rows. In an imaging pixel group 200 of two columns by two rows illustrated in FIG. 2, an imaging pixel 200R having spectral sensitivity of red (R) is disposed on the upper left, imaging pixels 200G each having spectral sensitivity of green (G) are disposed on the upper right and the lower left, and an imaging pixel 200B having spectral sensitivity of blue (B) is disposed on the lower right. Further, each of the imaging pixels includes a first focus detection pixel 201 and a second focus detection pixel 202 arranged in two columns by one row.

A large number of imaging pixel groups 200 arranged on the imaging plane make it possible to acquire captured images and focus detection signals.

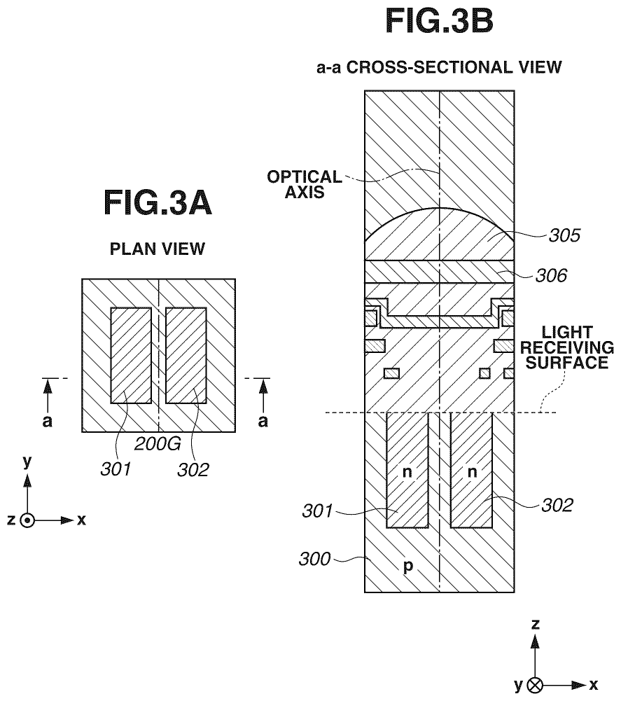

FIG. 3A illustrates one imaging pixel (hereinafter, simply referred to as a pixel) 200G of the imaging element 122 illustrated in FIG. 2 as viewed from a light receiving surface (the +z direction) of the imaging element 122. FIG. 3B illustrates a cross-section taken along a line a-a in FIG. 3A as viewed from the −y direction.

The pixel 200G includes a microlens 305 for collecting incident light, and a photoelectric conversion unit 301 and a photoelectric conversion unit 302 that are divided in the x-direction. The photoelectric conversion unit 301 and the photoelectric conversion unit 302 respectively correspond to the first focus detection pixel 201 and the second focus detection pixel 202 illustrated in FIG. 2.

The photoelectric conversion unit 301 and the photoelectric conversion unit 302 can each be a pin structure photodiode with an intrinsic layer placed between a p-type layer and an n-type layer, or can each be a pn junction photodiode without an intrinsic layer. The pixel 200G includes a color filter 306 between the microlens 305 and the two photoelectric conversion units 301 and 302. The spectral transmittance of the color filter can be changed for each photoelectric conversion unit, or the color filter may not be included.

The light entered in the pixel 200G is focused by the microlens 305, spectrally separated by the color filter 306, and then received by the photoelectric conversion unit 301 and the photoelectric conversion unit 302. In the photoelectric conversion unit 301 and the photoelectric conversion unit 302 each, electron-hole pairs are generated based on a light receiving amount. After the holes and the electrons are separated by a depletion layer, the negatively charged electrons accumulate in the n-type layer, while the holes are discharged to the outside of the imaging element 122 through the p-type layer connected to a not-illustrated constant voltage source.

The electrons accumulated in the n-type layers of the photoelectric conversion unit 301 and the photoelectric conversion unit 302 are transferred to a floating diffusion (FD) through a transfer gate, and converted into voltage signals.

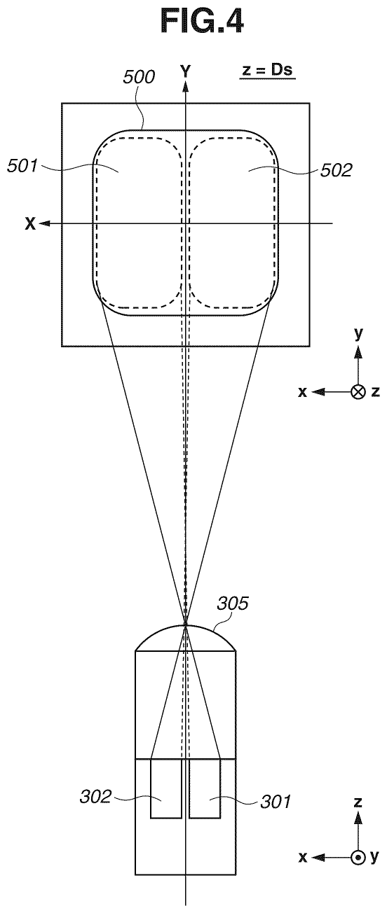

FIG. 4 illustrates a correspondence relationship between the pixel structure of the imaging element 122 illustrated in FIGS. 3A and 3B and the pupil division.

FIG. 4 illustrates a cross-section of the pixel structure of the imaging element 122 illustrated in FIG. 3A as viewed from the +y direction, and a pupil plane (a pupil distance Ds) of the imaging element 122. In FIG. 4, the x-axis and the y-axis of the cross-section of the imaging element 122 are inverted with respect to FIGS. 3A and 3B in order to correspond to coordinate axes of the pupil plane of the imaging element 122.

In FIG. 4, a first pupil partial area 501 is a light receivable area of the first focus detection pixel 201, which is substantially in a conjugate relationship with the light receiving surface of the photoelectric conversion unit 301 having the center of gravity decentered in the −x direction through the microlens 305. A second pupil partial area 502 is a light receivable area of the second focus detection pixel 202, which is substantially in a conjugate relationship with the light receiving surface of the photoelectric conversion unit 302 having the center of gravity decentered in the +x direction through the microlens 305. In FIG. 4, a pupil area 500 including the first and second pupil partial areas 501 and 502 is a light receivable area of the entire pixel 200G including the photoelectric conversion units 301 and 302 (first and second fucus detection pixels 201 and 202).

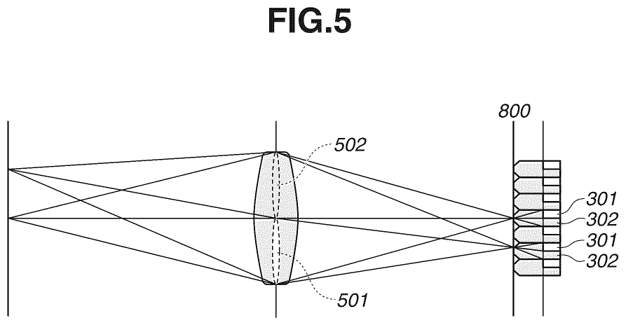

As illustrated in FIG. 5, the different light fluxes passing through the first pupil partial area 501 and the second pupil partial area 502 in the pupil area 500 of the imaging optical system enter each pixel on an imaging plane 800 at different angles, and are received by the first focus detection pixel 201 and the second focus detection pixel 202. FIG. 5 illustrates an example in which the pupil area is horizontally divided into two areas, but the pupil area can be vertically divided.

Photoelectric conversion signals from the first focus detection pixels 201 of the plurality of pixels are combined to generate a first focus detection signal, and photoelectric conversion signals from the second focus detection pixels 202 are combined to generate a second focus detection signal. In addition, the photoelectric conversion signals from the first and second focus detection pixels 201 and 202 are added in each pixel to generate an imaging signal with the resolution of N effective pixels. The second focus detection signal can be generated by subtracting the first focus detection signal from the imaging signal.

In the above description of the imaging element 122, the plurality of photoelectric conversion units is provided for one microlens, and the focus detection signals and the image generation signals are output from the photoelectric conversion units. However, the configuration is not limited thereto. For example, imaging pixels used for image generation and focus detection pixels used for focus adjustment can be included.

### <Relationship Between a Defocus Amount and an Image Shift Amount in One or More Embodiments>

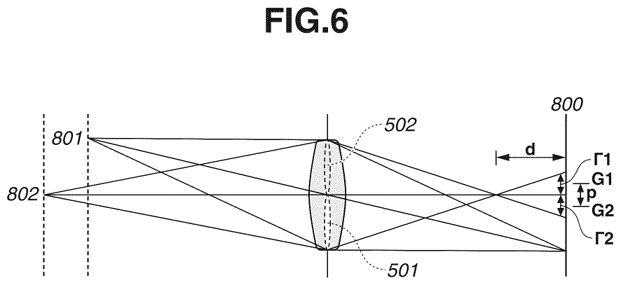

FIG. 6 illustrates a relationship between defocus amounts and image shift amounts between the first and second focus detection signals. As illustrated in FIG. 5, the pupil area of the imaging optical system is divided into the first pupil partial area 501 and the second pupil partial area 502. A defocus amount d is defined as the distance |d| from an image-forming position of the object image to the imaging plane 800. A front-focused state where the image-forming position of an object image is closer to the object than the imaging plane 800 is indicated by a negative sign (d<0). A back-focused state where the image-forming position of an object image is opposite from the object relative to the imaging plane 800 is indicated by a positive sign (d>0). An in-focus state where the image-forming position of an object image is on the imaging plane 800 is indicated as d=0. In FIG. 6, an object 801 indicates an object in the in-focus state (d=0), and an object 802 indicates an object in the front-focused state (d<0). The front-focused state (d<0) and the back-focused state (d>0) are collectively referred to as a defocus state (|d|>0).

In the front-focused state (d<0), the light fluxes from the object 802 through the first and second pupil partial areas 501 and 502, respectively, are once collected, and then spread to widths Γ1 and Γ2 around center of gravity positions G1 and G2 of the light fluxes, resulting in a blurred image on the imaging plane 800. When the blurred image is received by the first and second focus detection pixels 201 and 202, the first and second focus detection signals are generated. Thus, the first and second focus detection signals are recorded as an object image where the object 802 is blurred with the widths Γ1 and Γ2 at the center of gravity positions G1 and G2 on the imaging plane 800, respectively.

The blur widths Γ1 and Γ2 of the object image increases substantially in proportion to the magnitude |d| of the defocus amount d. Similarly, the magnitude |p| of an image shift amount p (the difference G1−G2 in the center gravity positions of light fluxes) between the first and second focus detection signals increases substantially in proportion to the magnitude |d| of the defocus amount d. In the back-focused state (d>0), the direction of the image shift between the first and second focus detection signals is opposite to the direction in the front-focused state, but otherwise the same.

The phase difference AF unit 129 converts an image shift amount into the defocus amount d by using a conversion coefficient calculated based on a distance (a baseline length) between the first and second focus detection pixels 201 and 202 due to the relationship in which the image shift amount between the first and second focus detection signals increases with the increase of the defocus amount.

### <Imaging Processing for One or More Embodiments>

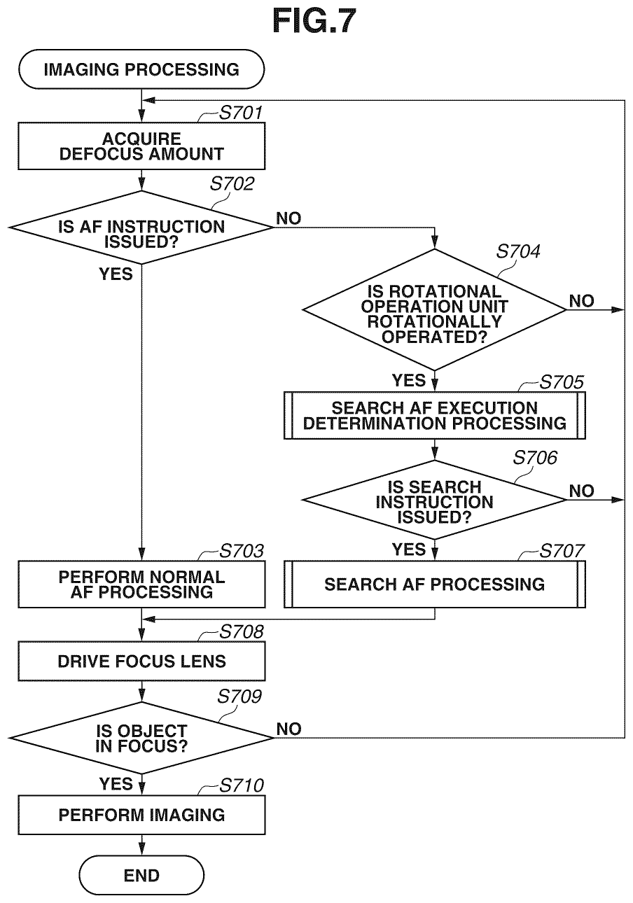

FIG. 7 is a flowchart illustrating imaging processing performed by the camera MPU 125 based on programs according to one or more embodiments of the present disclosure.

In step S701, the camera MPU 125 causes the phase difference AF unit 129 to perform focus detection, and acquires a defocus amount as the focus detection result and the reliability thereof. The defocus amount includes a defocus direction. In step S702, the camera MPU 125 determines whether an AF instruction is issued. If the AF instruction is issued (YES in step S702), the processing proceeds to step S703. If the AF instruction is not issued (NO in step S702), the processing proceeds to step S704. In step S703, the camera MPU 125 performs normal AF (imaging plane phase difference AF) processing, and sets a driving amount of the focus lens 104 (hereinafter, referred to as focus driving amount) corresponding to the defocus amount acquired in step S701. The processing then proceeds to step S708.

In step S704, the camera MPU 125 determines whether the rotational operation unit 105 is rotationally operated from an operation amount of the rotational operation unit 105 notified from the lens MPU 117 in response to a request from the camera MPU 125. If the rotational operation unit 105 is rotationally operated (YES in step S704), the processing proceeds to step S705. If the rotational operation unit 105 is not rotationally operated (NO in step S704), the processing proceeds to step S701.

In step S705, the camera MPU 125 performs search AF execution determination processing. The search AF execution determination processing will be described below.

In step S706, the camera MPU 125 determines whether a search instruction is issued based on the determination in step S705. If a search instruction is issued (YES in step S706), the processing proceeds to step S707. If no search instruction is issued (NO in step S706), the processing proceeds to step S701.

In step S707, the camera MPU 125 performs search AF processing. The processing then proceeds to step S708. The search AF processing will be described below.

In step S708, the camera MPU 125 transmits the focus driving amount set in step S703 or S707 to the lens MPU 117, and drives the focus lens 104.

In step S709, the camera MPU 125 determines whether the imaging optical system focuses on the object. If the imaging optical system focuses on the object (YES in step S709), the processing proceeds to step S710. If the imaging optical system does not focus on the object (NO in step S709), the processing proceeds to step S701.

In step S710, the camera MPU 125 performs imaging for recording. When the imaging is completed, the processing ends.

### <Search AF Execution Determination Processing for One or More Embodiments>

The search AF execution determination processing in step S705 in FIG. 7 will be described.

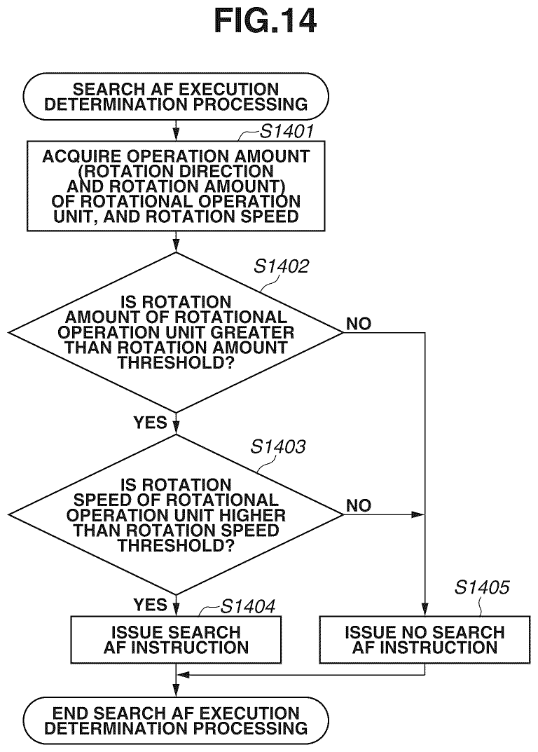

FIG. 14 is a flowchart illustrating the search AF execution determination processing performed by the camera MPU 125.

In step S1401, the camera MPU 125 acquires an operation amount (a rotation direction and a rotation amount) of the rotational operation unit 105 detected by the rotational position detection unit 106 of the lens unit 100, and information about the rotation speed calculated by the lens MPU 117.

In step S1402, the camera MPU 125 determines whether the rotation amount of the rotational operation unit 105 is greater than a predetermined rotation amount threshold previously stored in the ROM 125a. If the rotation amount is greater than the predetermined rotation amount threshold (YES in step S1402), the processing proceeds to step S1403. If the rotation amount is less than or equal to the predetermined rotation amount threshold (NO in step S1402), the processing proceeds to step S1405.

In step S1403, the camera MPU 125 determines whether the rotation speed of the rotational operation unit 105 is higher than a predetermined rotation speed threshold previously stored in the ROM 125a. If the rotation speed is higher than the predetermined rotation speed threshold (YES in step S1403), the processing proceeds to step S1404. If the rotation speed is less than or equal to the predetermined rotation speed threshold (NO in step S1403), the processing proceeds to step S1405.

In step S1404, the camera MPU 125 issues a search AF operation instruction since the rotation amount and the rotation speed of the rotational operation unit 105 are greater than the corresponding predetermined amounts and the possibility of erroneous operation by the user is low. On the other hand, in step S1405, the camera MPU 125 does not issue the search AF operation instruction since the rotation amount or the rotation speed of the rotational operation unit 105 is less than or equal to the corresponding predetermined amount, and the possibility of erroneous operation by the user is high.

When the processing in step S1404 or S1405 is completed, the search AF execution determination processing ends.

### <Search AF Processing for One or More Embodiments>

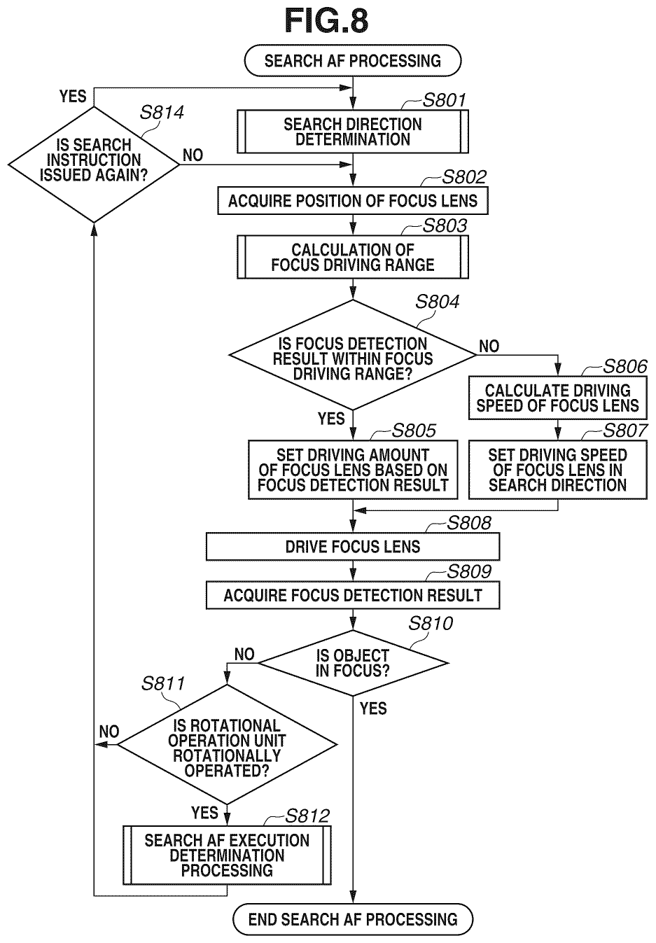

The search AF processing in step S707 in FIG. 7 will be described. FIG. 8 is a flowchart illustrating the search AF processing performed by the camera MPU 125. In the search AF (processing), to search for an in-focus position of the focus lens 104, a search operation (hereinafter, also simply referred to as a search) for performing a focus detection at predetermined intervals while moving the focus lens 104 is performed. Thereafter, the focus lens 104 is moved to the in-focus position determined by the search.

In step S801, the camera MPU 125 determines the lens driving direction in the search operation. In one or more embodiments, the lens driving direction in the search operation is determined based on the rotation direction of the rotational operation unit 105 acquired in step S1401. A relationship between the rotation direction of the rotational operation unit 105 and the driving direction of the focus lens 104 is set to be consistent whether the manual focus (MF) function or the search AF function is assigned to the rotational operation unit 105. As an example, a case will be described where the manual focus (MF) function is assigned to the rotational operation unit 105. When the rotational operation unit 105 is rotated to the left, the focus position is set to move to the infinity end. When the rotational operation unit 105 is rotated to the right, the focus position is set to move to the close-up end. In the above-described setting state, with the search AF function assigned to the rotational operation unit 105, the search direction is determined such that rotating the rotational operation unit 105 to the left causes the search drive to start in the direction where the focus position moves to the infinity end. Conversely, the search direction is determined such that rotating the rotational operation unit 105 to the right causes the search drive to start in the direction where the focus position moves to the close-up end. In one or more embodiments, the relationship between the rotation direction of the rotational operation unit 105 and the driving direction of the focus lens 104 is described as an example. However, the above-described relationship can be set in the opposite manner by the user.

In step S802, the camera MPU 125 acquires a current position of the focus lens 104 from the lens MPU 117.

In step S803, the camera MPU 125 calculates a driving range of the focus lens 104 (hereinafter, referred to as a focus driving range). The calculation of the focus driving range will be described below.

In step S804, the camera MPU 125 determines whether the focus detection result (the defocus amount in one or more embodiments) acquired in step S701 or in step S809 described below is within the focus driving range calculated in step S803. If it is determined that the focus detection result is within the focus driving range (YES in step S804), the processing proceeds to step S805. If it is determined that the focus detection result is not within the focus driving range (NO in step S804), the processing proceeds to step S806. When the reliability of the focus detection result is low, and no available focus detection result exists, it is determined that the focus detection result is not within the focus driving range.

In step S805, the camera MPU 125 sets a driving amount of the focus lens 104 based on the focus detection result acquired in step S701 or in step S809 described below.

In step S806, the camera MPU 125 determines the driving speed of the focus lens 104 for the search operation without using the focus detection result acquired in step S701 or in step S809 described below. The driving speed of the focus lens 104 is determined based on information about the rotation speed of the rotational operation unit 105 calculated by the lens MPU 117, and a correspondence table between rotation speeds of the rotational operation unit 105 and driving speeds of the focus lens 104 previously stored in the ROM 125a. In the above-described correspondence table, the driving speed of the focus lens 104 is increased when the rotation speed of the rotational operation unit 105 is higher, and the driving speed of the focus lens 104 is decreased when the rotation speed of the rotational operation unit 105 is lower.

In step S807, the camera MPU 125 sets the driving speed of the focus lens 104 determined in step S806.

In step S808, the camera MPU 125 drives the focus lens 104.

If the driving amount of the focus lens 104 is set in step S805, the focus lens 104 is step-driven based on the set driving amount. On the other hand, if the driving speed of the focus lens 104 is set in step S807, the focus lens 104 is search-driven based on the set driving speed.

In step S809, the camera MPU 125 controls the phase difference AF unit 129 to obtain a focus detection result for in-focus determination or for subsequent lens driving.

In step S810, the camera MPU 125 performs an in-focus determination. If it is determined that the imaging optical system focuses on the object (YES in step S810), the search AF operation ends. If it is determined that the imaging optical system does not focus on the object (NO in step S810), the processing proceeds to step S811.

In step S811, the camera MPU 125 determines whether the rotational operation unit 105 is rotationally operated based on the operation amount of the rotational operation unit 105 notified from the lens MPU 117 in response to a request from the camera MPU 125. If the rotational operation unit 105 is rotationally operated during the search AF (YES in step S811), the processing proceeds to step S812. If the rotational operation unit 105 is not rotationally operated (NO in step S811), the processing proceeds to step S814.

In step S812, the camera MPU 125 performs search AF execution determination processing equivalent to the search AF execution determination processing in step S705. The processing then proceeds to step S814.

In step S814, the camera MPU 125 determines whether a search instruction is issued again during the search AF. If a search instruction is issued again (YES in step S814), the processing returns to step S801. The camera MPU 125 determines the search direction again, and continues the search AF. If no search instruction is issued again (NO in step S814), the processing returns to step S802, and the camera MPU 128 continues the search AF.

If it is determined in step S810 that the imaging optical system focuses on the object, the search AF processing ends.

### <Calculation of Focus Driving Range for One or More Embodiments>

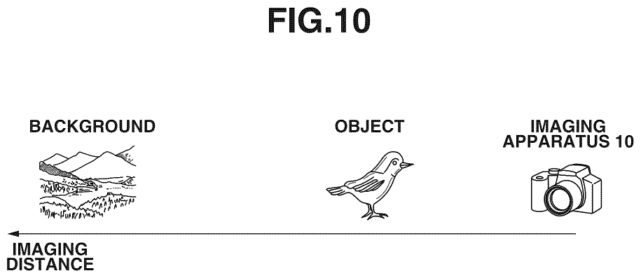

The calculation of the focus driving range in step S803 in FIG. 8 will now be described. FIG. 10 illustrates a positional relationship between the object and the background. The object is at a position closer to the imaging system 10 than the background, and the background is at a position sufficiently far from the imaging system 10.

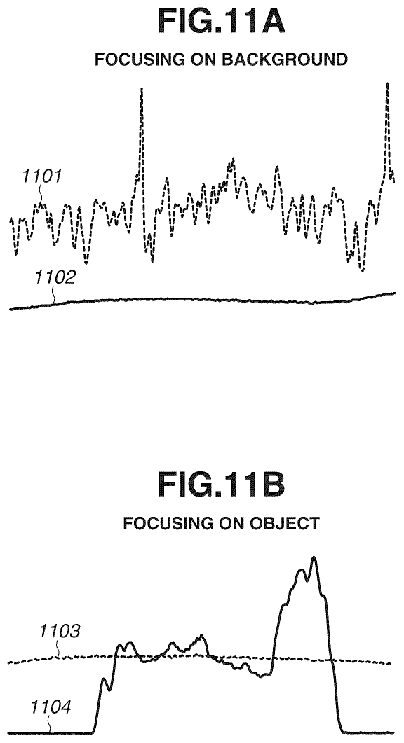

FIG. 11A and FIG. 11B each illustrate a signal indicating the object (hereinafter, referred to as an object signal) and a signal indicating the background (hereinafter, referred to as a background signal) acquired from the imaging element 122 when the object and the background have the positional relationship illustrated in FIG. 10. FIG. 11A illustrates an object signal 1102 and a background signal 1101 when the imaging optical system focuses on the background. FIG. 11B illustrates an object signal 1104 and a background signal 1103 when the imaging optical system focuses on the object. In reality, the object signal and the background signal are acquired as a combined signal from the imaging element 122, but the object signal and the background signal are separately illustrated in the drawings.

In a background in-focus state illustrated in FIG. 11A, the background signal 1101 has a high contrast while the object signal 1102 has a very low contrast. Thus, in the background in-focus state, due to large impact of the background signal 1101, a defocus amount relative to the background is detected as the focus detection result. On the other hand, in an object in-focus state illustrated in FIG. 11B, the object signal 1104 has a high contrast while the background signal 1103 has a very low contrast. Thus, in the object in-focus state, due to large impact of the object signal 1104, a defocus amount relative to the object is detected as the focus detection result.

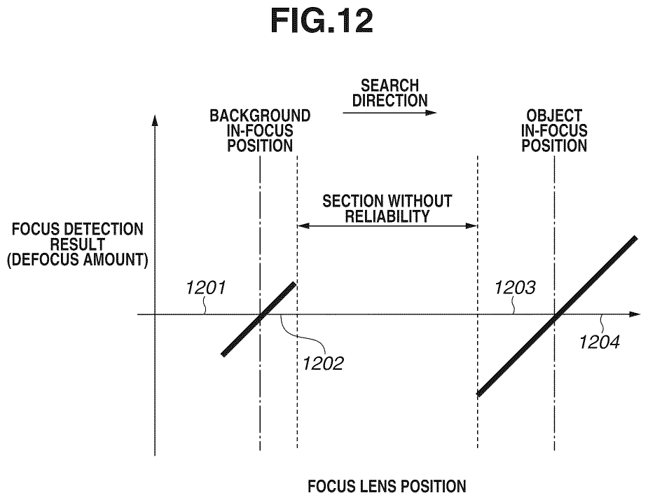

FIG. 12 illustrates a relationship between focus lens positions and focus detection results when the object and the background have the positional relationship illustrated in FIG. 10. The horizontal axis indicates the focus lens position, and the vertical axis indicates the defocus amount. The search direction is a direction from a longer focusing distance (the background) to a shorter focusing distance (object).

When the focus lens position is in the vicinity (a position 1201 or a position 1202) of a background in-focus position, due to the large impact of the background signal as described above, a defocus amount relative to the background is detected.

On the other hand, when the focus lens position is in the vicinity (a position 1203 or a position 1204) of an object in-focus position, due to the large impact of the object signal, a defocus amount relative to the object is detected. In a section between the vicinity of the background in-focus position and the vicinity of the object in-focus position, the contrast of the background signal and the contrast of the object signal are both low. Thus, the reliability of defocus amounts is low, and no defocus amount available for AF can be detected.

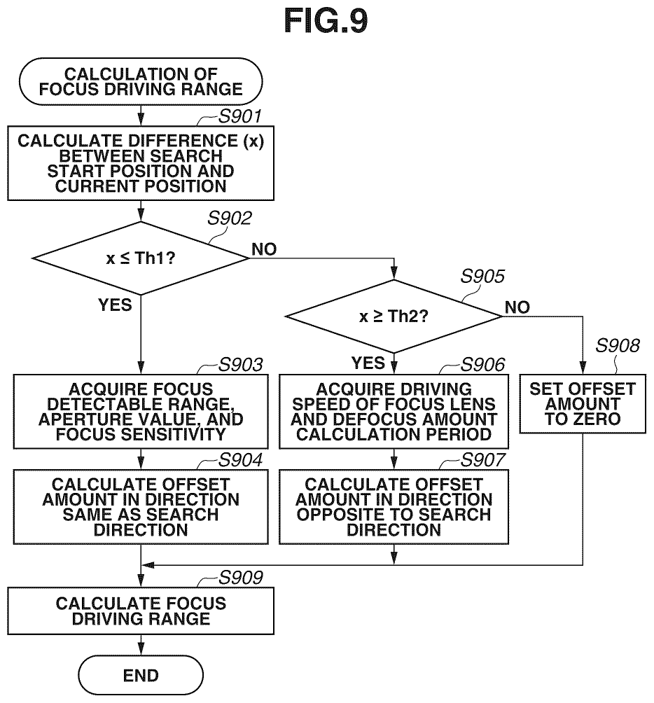

FIG. 9 is a flowchart illustrating a calculation of the focus driving range performed by the camera MPU 125. In step S901, a difference x is calculated between the search start position of the focus lens 104 acquired in step S802 at the start of the search AF (at the search start) and the current position of the focus lens 104 acquired in step S802 in the current frame.

In step S902, it is determined whether the difference x is less than or equal to a predetermined first threshold Th1. If the difference x is less than or equal to the first threshold Th1 (YES in step S902), the processing proceeds to step S903. If the difference x is not less than or equal to the first threshold Th1 (NO in step S902), the processing proceeds to step S905.

In step S903, a focus detectable range of the phase difference AF unit 129 is acquired, and the set aperture value and a focus sensitivity (optical information about imaging optical system) are acquired from the lens MPU 117. The focus detectable range is an image blur amount (the spreading amount of an object image) detectable by the phase difference AF unit 129. The focus sensitivity indicates a relationship (a ratio) between a unit driving amount of the focus lens 104 and a change amount in the defocus amount.

In step S904, an offset amount in the same direction as the search direction acquired in step S801 is calculated based on the difference x calculated in step S901, and the focus detectable range R, the aperture value F, and the focus sensitivity S acquired in step S903. The offset amount is a driving amount of the focus lens 104 calculated in consideration of a case where the search start position is in a direction opposite to the search direction relative to the background in-focus position, and is calculated by, for example, the following equation (1), where a is a predetermined gain value:

Offset amount=α(R/x)FS.

When an image blur amount exceeds the focus detectable range with respect to the object in the vicinity of the search start position, a focus detection result for the object cannot be obtained. Thus, it is unnecessary for an offset amount that causes the image blur amount to exceed the focus detectable range to be set. In such a case, an offset amount is set based on the focus detectable range.

As the current position of the focus lens 104 moves away from the search start position, the likelihood that the current position exceeds the background in-focus position increases. Thus, the offset amount is reduced in inverse proportion to the difference x between the search start position and the current position as the current position moves farther away from the search start position to prevent an excessively large offset amount from being set. The aperture value F is used to convert an image blur amount into the defocus amount. The focus sensitivity is used to convert a defocus amount into the focus driving amount. The equation (1) is an example of calculating an offset amount, and an offset amount can be calculated by other methods. After step S904, the processing proceeds to step S909.

In step S909, the focus driving range is calculated based on the current position of the focus lens 104, the offset amount calculated in step S904, and the search direction acquired in step S801. The focus driving range is a range from a position shifted (separated) from the current position in the search direction by the offset amount to a driving end (an end in control or a mechanical end) of the focus lens 104 in the search direction. After the focus driving range is calculated, the processing ends.

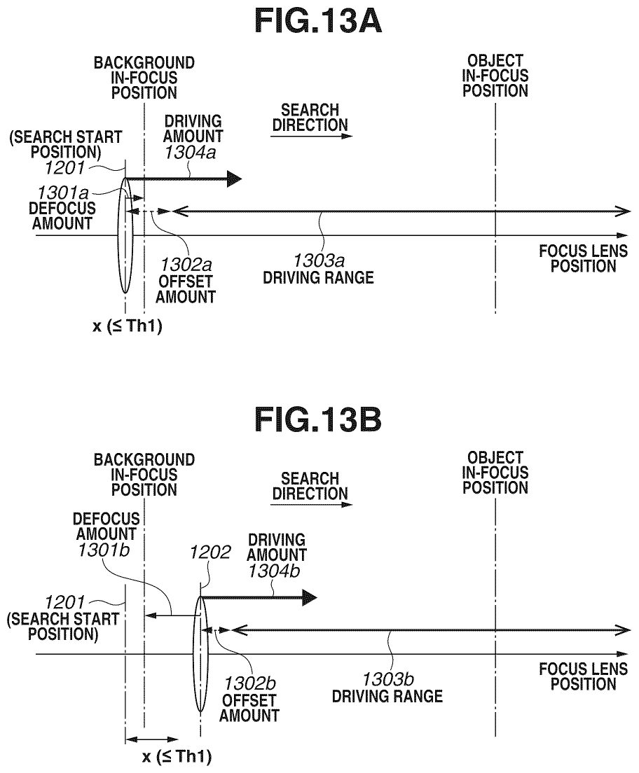

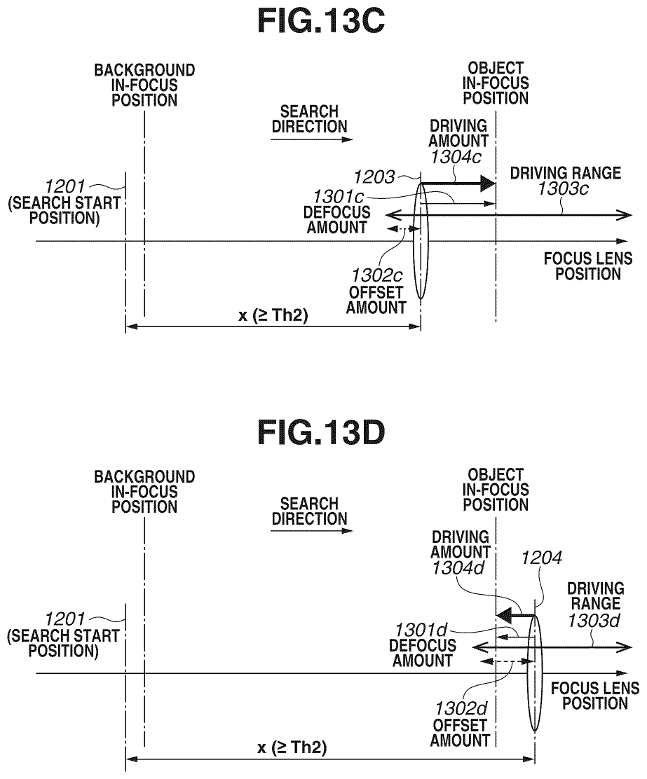

FIGS. 13A to 13D each illustrate a relationship between the search direction, the search start position, the focus lens position, the focus driving range, the defocus amount, and the focus driving amount according to one or more embodiments. Focus positions (current positions) 1201 to 1204 in the drawings correspond to the positions 1201 to 1204 illustrated in FIG. 12.

FIG. 13A illustrates a state at the search start, and the focus lens 104 is positioned at the search start position as the current position 1201. In this state, x (=0)≤Th1 is satisfied. Thus, in step S904, an offset amount 1302a is set in the same direction as the search direction based on the focus detectable range, the aperture value, the focus sensitivity, and the difference x. A focus driving range 1303a is set in the search direction from a position that is shifted from the search start position in the search direction by the offset amount 1302a. In this state, a defocus amount 1301a up to the background in-focus position is detected. However, the background in-focus position as a target position of the focus lens 104 based on the defocus amount 1301a is out of the focus driving range 1303a. Thus, the defocus amount 1301a is not used, and the lens is search-driven based on the driving speed set in step S807.

As described above, the focus driving range that is shifted from the search start position (the current position) in the search direction by the offset amount is set. This makes it possible to search for the object in-focus position without focusing on the background even when the search start position is positioned in the direction opposite to the search direction relative to the background in-focus position.

FIG. 13B illustrates a state where the focus lens 104 is moved from the search start position to the current position 1202 closer to the object in-focus position than the background in-focus position. Even in this state, x(>0)≤Th1 is satisfied. Thus, in step S904, an offset amount 1302b is set in the same direction as the search direction based on the focus detectable range, the aperture value, the focus sensitivity, and the difference x. A focus driving range 1303b is set in the search direction from a position that is shifted from the current position 1202 by the offset amount 1302b. The difference x is greater than the difference x in the state illustrated in FIG. 13A. Thus, the offset amount 1302b is smaller than the offset amount 1302a. Even in this state, a defocus amount 1301b up to the background in-focus position is detected. However, the background in-focus position as a target position of the focus lens 104 based on the defocus amount 1301b is out of the focus driving range 1303b. Thus, the defocus amount 1301b is not used, and the lens is search-driven based on the driving speed set in step S807. The focus driving amount 1304b is equal to the focus driving amount 1304a illustrated in FIG. 13A, but can be different, such as being smaller.

As described above, the focus driving range that is shifted from the focus lens position after the search start by the offset amount is set. This makes it possible to search for the object in-focus position without focusing on the background even when the detected defocus amount 1301a indicates a position within the focus driving range (1303a) set at the search start.

In step S905 in FIG. 9, the camera MPU 125 determines whether the difference x is greater than or equal to a predetermined second threshold Th2 (>Th1). If the difference x is greater than or equal to the threshold Th2 (YES in step S905), the processing proceeds to step S906. If the difference x is not greater than or equal to the threshold Th2 (NO in step S905), the processing proceeds to step S908.

In step S906, the camera MPU 125 acquires a driving speed of the focus lens 104 and focus detection interval.

In step S907, the camera MPU 125 calculates an offset amount in a direction opposite to the search direction acquired in step S801 based on the driving speed and the focus detection interval acquired in step S906, as well as the difference x calculated in step S901. The offset amount is set in consideration of a case where the focus lens 104 overshoots the object in-focus position during the search due to the relationship between a driving speed v of the focus lens 104 and a focus detection interval T, and is calculated using, for example, the following equation (2), where R is a predetermined gain value:

Offset amount=βvTx.

The driving amount of the focus lens 104 between frames in which focus detection is performed is calculated by the product of the driving speed v and the focus detection interval T. The driving amount of the focus lens 104 between the above-described frames is the maximum amount by which the object in-focus position is overshot. Thus, the offset amount is set based on the driving amount. As the focus lens 104 moves farther away from the search start position, the likelihood that the position of the focus lens 104 overshoots the object in-focus position increases. Thus, increasing the offset amount in proportion to the difference x between the search start position and the current position of the focus lens 104 makes it easier to capture the object in-focus position within the driving range even if overshooting occurs. In other words, the range is narrowed to reduce the risk of returning to the background since the likelihood of overshooting is low at the search start. As the distance from the start position increases, the risk of returning to the background decreases while and the risk of overshooting increases. Thus, the driving range is extended in the search direction. This makes it easier to keep the object in-focus position within the driving range even if overshooting occurs. The above-described method of calculating the offset amount is merely an example, and the offset amount can be calculated by other methods. For example, the offset amount (i.e., the focus driving range) can be set based on either the driving speed of the focus lens 104 or the focus detection interval.

In step S908, the camera MPU 125 sets the offset amount to zero.

Thereafter, the processing proceeds to step S909, and the focus driving range is calculated in the above-described manner. The processing then ends.

FIG. 13C illustrates a state where the focus lens 104 is moved to the current position 1203, which is closer to the object in-focus position than in the state illustrated in FIG. 13B. In this state, x≥Th2 is satisfied. Thus, in step S907, an offset amount 1302c is set in a direction opposite to the search direction based on the driving speed of the focus lens 104, the focus detection interval, and the difference x. A focus driving range 1303c is set in the search direction from a position that is shifted from the current position 1203 in the direction opposite to the search direction by the offset amount 1302c. In this state, a defocus amount 1301c up to the object in-focus position is detected, and the object in-focus position as a target position of the focus lens 104 based on the defocus amount 1301c is within the focus driving range 1303c. Thus, in step S805, a focus driving amount 1304c is set based on the defocus amount 1301c.

As described above, the focus driving range is set in the search direction from the position that is shifted from the current position of the focus lens 104 in the direction opposite to the search direction by the offset amount. This allows the focus lens 104 to be driven based on the defocus amount detected at the timing when the object in-focus position is within the focus driving range, enabling the object to be brought into focus.

FIG. 13D illustrates a state where the focus lens 104 is moved to the current position 1204, the state in which the focus lens 104 has overshot the object in-focus position. Even in this state, x≥Th2 is satisfied. Thus, in step S907, an offset amount 1302d is set in a direction opposite to the search direction based on the driving speed of the focus lens 104, the focus detection interval, and the difference x. A focus driving range 1303d is set in the search direction from a position that is shifted from the current position 1204 in the direction opposite to the search direction by the offset amount 1302d. The difference x is greater than the difference x in the state illustrated in FIG. 13C. Thus, the offset amount 1302d is greater than the offset amount 1302c. In this state, a defocus amount 1301d up to the object in-focus position that is positioned in the direction opposite to the search direction is detected, and the object in-focus position as a target position of the focus lens 104 based on the defocus amount 1301d is within the focus driving range 1303d. Thus, a focus driving amount 1304d is set based on the defocus amount 1301d.

As described above, the focus driving range is set in the search direction from the position that is shifted from the current position of the focus lens 104 in the direction opposite to the search direction by the offset amount. This allows the focus lens 104 to be driven based on the defocus amount even when the focus lens 104 has overshot the object in-focus position in the search direction, enabling the object to be brought into focus.

As described above, in one or more embodiments, the focus driving range is set from the position that is shifted from the current position of the focus lens 104 by the offset amount. Further, the focus driving amount is set based on whether the focus detection result is obtained for a position within the focus driving range. This makes it possible to perform the appropriate search AF on the object desired by the user and quickly focus on the object.

### <Method of Setting Function to be Assigned to Ring Member (Rotational Operation Unit 105) on Outer Periphery of Lens Barrel for One or More Embodiments>

The search AF specific to one or more embodiments including the operation procedure has been described in detail above.

A method of setting the search AF function will now be described.

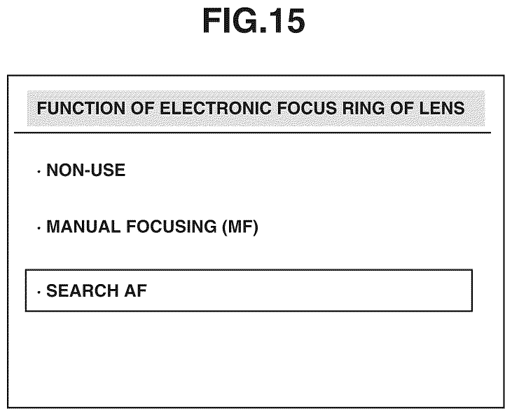

FIG. 15 is a diagram illustrating an example of a setting screen displayed on the display unit 126 when a function is assigned to the rotational operation unit 105. When the user selects a “function of electronic focus ring of lens” menu in a setting menu screen of the camera, and the screen is transitioned to a setting screen. In one or more embodiments, the menu is configured such that the operation of the rotational operation unit 105 is previously limited to the function of the focus lens, but other functions can be assigned. In the setting menu, when no functional assignment of the rotational operation unit 105 is used, “non-use” is selected. When the manual focus (MF) function is assigned to the rotational operation unit 105, “manual focusing (MF)” is selected. When the search AF function is assigned to the rotational operation unit 105, “search AF” is selected. In one or more embodiments, it may be on the assumption that a single ring member is disposed on the outer periphery of the lens barrel. Thus, the conflicting operations of “manual focusing (MF)” and “search AF” are configured as exclusive settings. In one or more embodiments, the control function of “search AF” may be assigned to the rotational operation unit 105.

### <Display Screen During Execution of Search AF for One or More Embodiments>

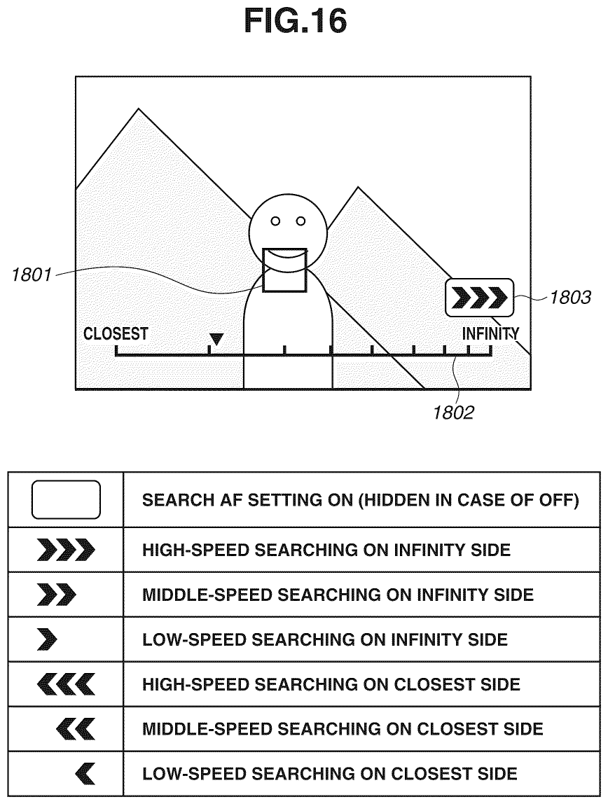

FIG. 16 illustrates an example of a display screen of the display unit 126 during execution of the search AF.

In FIG. 16, a frame 1801 is an example of an AF frame, an item 1802 is an example of an item that indicates a position of the focusing ring of a lens, and an item 1803 is an example of an item that indicates an execution status of the search AF. The item 1803 desirably indicates on the rear liquid crystal display of the camera whether the search AF is set, as well as the lens driving direction and the driving speed of the search operation via an icon to be displayed. In one or more embodiments, as an example, arrows are displayed while the number and a direction of the arrows are associated with the driving direction and the driving speed of the search operation illustrated in FIG. 16. The item may indicate alone, as the execution status of the search AF, whether the search operation is being performed.

With the display screen according to one or more embodiments, erroneous operation by the user may be prevented, and rapid resetting may be performed when the lens is in a not-intended driven state.

According to one or more embodiments, a focus control apparatus may be provided that allows search processing to be performed with more intuitive operation.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc™ (BD)), a flash memory device, a memory card, and the like.

While one or more features of the present disclosure have been described with reference to exemplary embodiments, it is to be understood that the scope of the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-079798, filed May 15, 2024, which is hereby incorporated by reference herein in its entirety.

What is claimed is:

1. A focus control apparatus comprising:
one or more processors that execute a program stored in a memory, the one or more processors operating to function as:
a focus detection unit that operates to perform a focus detection; and
a control unit that operates to control a driving of a focus lens included in an optical system based on a focus detection result obtained by the focus detection,
wherein the control unit: (i) performs control to cause a relationship between a rotation direction of a ring member that operates to be rotated and a driving direction of the focus lens to correspond to a relationship between the rotation direction of the ring member and a search direction, and (ii) starts a search operation in which the focus detection is performed at predetermined intervals while the focus lens is moved based on a rotation amount of the ring member.

2. The focus control apparatus according to claim 1, wherein, in a case where the ring member is rotated by a user and the rotation amount of the ring member is less than a predetermined amount, the control unit does not start the search operation of the focus lens.

3. The focus control apparatus according to claim 1, wherein, in a case where the ring member is rotated by a user and a rotation speed of the ring member is lower than a predetermined speed, the control unit does not start the search operation of the focus lens.

4. The focus control apparatus according to claim 1, wherein the control unit determines a driving speed of the focus lens based on a rotation speed of the ring member.

5. The focus control apparatus according to claim 1, wherein the control unit starts a first search operation for starting the search operation based on the rotation amount of the ring member, and, in a case where the ring member is operated during the first search operation or after the first search operation, the control unit starts a second search operation based on the rotation amount of the ring member.

6. The focus control apparatus according to claim 5, wherein, in a case where the ring member is rotated in an opposite direction during the first search operation and the second search operation, the control unit sets a driving speed of the focus lens in the second search operation to be lower than a driving speed of the focus lens in the first search operation.

7. The focus control apparatus according to claim 1, further comprising a reception unit that operates to receive a manual focus operation,
wherein, in a case where the manual focus operation is received, the control unit does not start the search operation of the focus lens.

8. The focus control apparatus according to claim 1, further comprising a display control unit that operates to control a display unit to display an item that indicates an execution status of the search operation.

9. The focus control apparatus according to claim 1, further comprising a display control unit that operates to control a display unit to display an item that indicates a position of a focusing ring of the focus lens.

10. An imaging apparatus comprising:
the focus control apparatus according to claim 1; and
an imaging element that operates to image an object through the optical system.

11. A focus control method comprising:
performing a focus detection; and
controlling a driving of a focus lens included in an optical system based on a focus detection result obtained by the focus detection,
wherein: (i) a control is performed to cause a relationship between a rotation direction of a rotation of a ring member and a driving direction of the focus lens to correspond to a relationship between the rotation direction of the rotation of the ring member and a search direction, and (ii) a search operation in which the focus detection is performed at predetermined intervals while the focus lens is moved is started based on a rotation amount of the rotation of the ring member.

12. A non-transitory computer-readable storage medium storing a program for causing a computer to perform the focus control method according to claim 11.
